(19) United States
(12) Patent Application Publication
(10) Pub. No.: US 2016/0119293 A1
(43) Pub. Date: Apr. 28, 2016

(54) System and Method for Authenticating and Encrypting Data Transmitted To and From the Devices and Cloud Servers

(71) Applicant: Orange Rock Consulting, LLC, Glendale, CA (US)

(72) Inventor: John Leon, Anaheim Hills, CA (US)

(73) Assignee: Orange Rock Consulting, LLC, Glendale, CA (US)

(21) Appl. No.: 14/273,536

(22) Filed: May 8, 2014

Related U.S. Application Data
(60) Provisional application No. 61/821,095, filed on May 8, 2013.

(51) Int. Cl. H04L 29/06; H04L 9/14

(52) U.S. Cl. CPC H04L 63/0428; H04L 9/14; H04L 2209/24

(57) ABSTRACT

A method is provided of authenticating and encrypting data transmitted between a user and a remote cloud server, where the method includes providing a computer user interface for the exchange and transmission of digital information between the user and the cloud server; permitting the user to establish a private user encryption key; and automatically establishing a public user encryption key; whereby the user may digitally transmit information using both the public and private keys so that the recipient of such information may only access such information if such recipient is pre-provided with both the public and private encryption keys.

### RELATED APPLICATION

The present application takes priority from provisional application Ser. No. 61/821,095 filed on May 8, 2013, the entire contents of which are incorporated herein in its entirety by reference.

### BACKGROUND

The embodiments herein relate generally to collection and transmission of encrypted data that is particularly useful in the cloud-based data storage and retrieval as well as medical treatment. Although there are downloadable applications and software developed for collecting and transmitting medical data, the prior systems are lacking in one respect or another, including lack of encryption, lack of accessibility and difficulty in maintaining real-time patient updates. Thus, a need exists for a solution to at least some of these problems, as well as others.

### SUMMARY

In one embodiment of the invention, a method is provided of authenticating and encrypting data transmitted between a user and a remote cloud server, where the method comprises providing a computer user interface for the exchange and transmission of digital information between the user and the cloud server; permitting the user to establish a private user encryption key; and automatically establishing a public user encryption key; whereby the user may digitally transmit information using both the public and private keys so that the recipient of such information may only access such information if such recipient is pre-provided with both the public and private encryption keys.

In another embodiment of the invention, an application suitable for use in medical applications is provided. In one embodiment, the application is configured for the secure exchange of information between patients and medical personnel, where such information is collected from multiple sources and may be transmitted periodically and/or in real time, the application configured for download as a platform to a mobile device and further configured to interface with data stored on the mobile device in association with other applications on the mobile device, where such information comprises at least one available source of data collected by the application, the application further comprising a user interface in the form of a set-up screen displayed on the mobile device in which the user of the application may designate one or more of the other applications on the mobile device that the user wants the application to collect data from, the user interface further permitting the establishment of a private user encryption key by the user, while the application automatically establishes a public user encryption key, at least another source of information to be collected comprising information entered directly by the user into a data file associated with the application, whereby such user-entered information may be combined with data collected from other data files on the mobile device and transmitted between the user's mobile device and one or more medical personnel to permit such medical personnel to monitor health-related information about the user and, thus, the health of the user, the application further configured to encrypt substantially all information transmitted using both the public and private keys so that the recipient of such information may only access such information if such recipient is pre-provided with both the public and private encryption keys.

### BRIEF DESCRIPTION OF THE DRAWINGS

FIG. 1 is a schematic view of one embodiment of the application as installed on a mobile device, such as the Apple iPhone® and the Samsung Galaxy® smart phones;

FIG. 2 is an example of the layout and content of a set-up screen within one embodiment of the inventive application;

FIG. 3 shows schematically the types of behavioral issues that embodiments of the present inventive mobile device application may use in exchanging information so that members of the medical community can make a diagnosis;

FIG. 4 shows a schematic overview of an embodiment of the present invention mobile device application, including a text-to-doctor feature;

FIG. 5 shows a schematic view of data flow to and from an end user to a medical group (without a Cloud Network);

FIG. 6 shows an example of mobile device application screen shots; and

FIG. 7 shows a schematic view of one embodiment of the invention as applied to a user's digital communication with the cloud.

### DETAILED DESCRIPTION OF CERTAIN EMBODIMENTS

In one embodiment, an application for mobile devices is provided that allows for secure transmission of information from the patient and their family members to the clinicians on current issues, relationship stresses and situational stressors to provide a thorough picture of the patient's current mental health status. Among other benefits, embodiments of the inventive application address at least some of the behavioral issues that the military has had difficulty in diagnosing historically, such as post-traumatic stress disorder (PTSD).

Patient/doctor confidentiality is a necessity faced by the military community as well as commercial/general medical use. There are many applications available for mobile devices and personal computing to track the activity and medical statistics of the individual for their own use. The ability to “share” this information with a doctor in confidence over a public network is a challenge. The challenge is not being able to secure the sending or receiving of the information but having the doctor and patient support the many interfaces that are currently in use to securely transfer/receive the information.

Embodiments of the mobile application provide a secure platform for the medical community to exchange information between patients and members of the medical community. The secure platform can include the use of Cloud networking for authentication and security measures. The applications are configured to permit secure exchange of data to securely monitor and provide real-time analysis for the clinician to review. The secure platform also includes an ability to integrate and communicate with aspects of third party applications already downloaded to the mobile devices on which the inventive application resides. While embodiments of the application described herein focus on the exchange of medical data, the invention is not limited to the encrypted real-time exchange of data that is medical related, but any type of data that can be transmitted in one or more of numerous types of formats, included text, photos, audio, videos, etc. Importantly, the embodiments include the ability to exchange at least a substantial portion of the data in encrypted form.

Embodiments of the present inventive application are configured as more than just another common application loaded on a smart phone or other mobile device. The embodiments more reflect an application platform that permits third party APPS to connect their file information with the information exchanged using the inventive application. In some embodiments, the inventive application is downloaded, similar to other applications, but integrates a user set-up methodology that permits the user to integrate information gathered and stored in association with other medical applications presently used or being developed for use. Embodiments comprise a library of information about the patient where such information may be entered by the patient directly, received from members of the medical community, or drawn from other medical application storage files on the same mobile device. During user set-up, it is contemplated that the user would need to enter security information associated with the third-party medical applications to permit exchange of information between the inventive application embodiments and the third-party applications. Regular use of the present inventive applications will give the clinician essentially constant and current input, which is critical in diagnosis and immediate treatment.

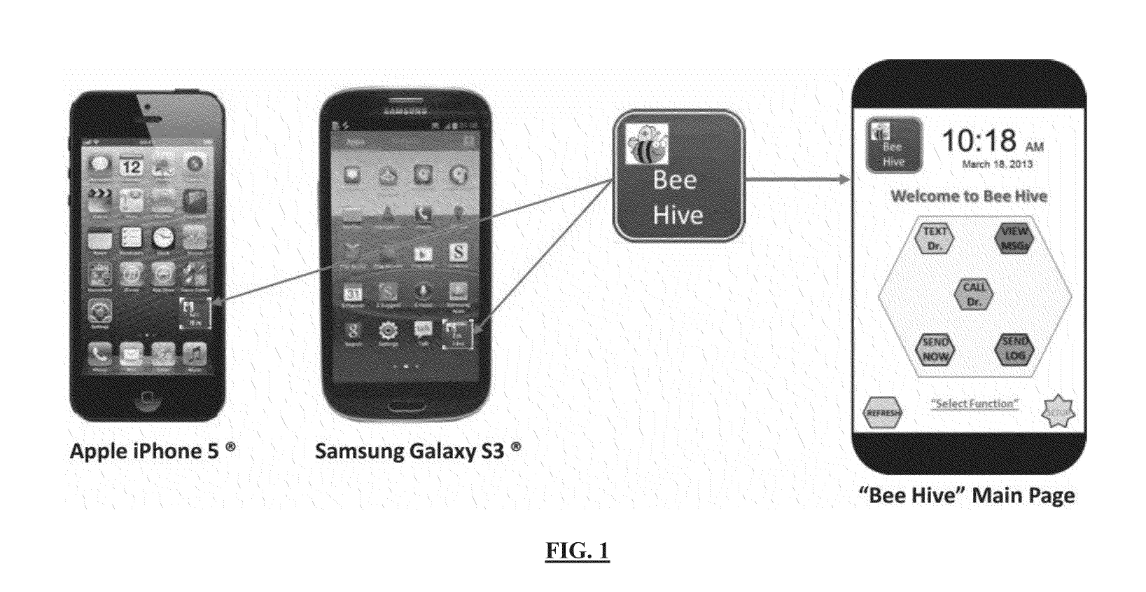

For purposes of this disclosure, a fanciful name—Bee Hive App—is used to reflect one or more embodiments of the inventive application. When the application is activated, a main page is displayed, such as that shown in FIG. 1.

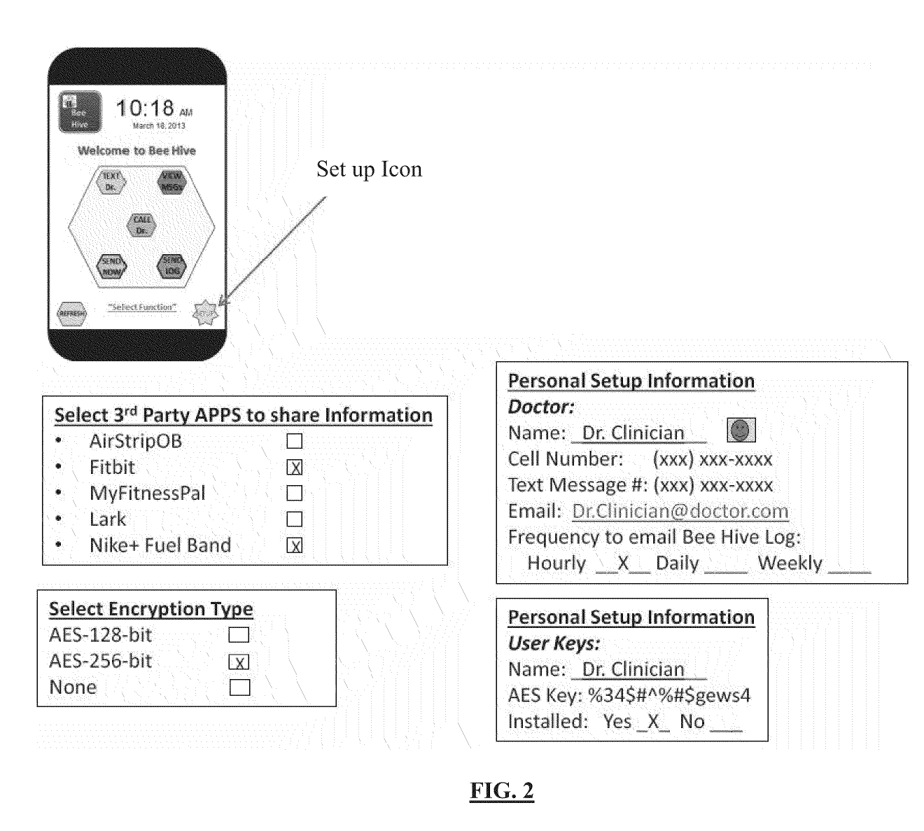

In one embodiment, the APP is configured to secure 100% all of the APP data using AES-128 or AED-256 bit encryption, as shown by example in FIG. 2. The encryption capability is configured in the set-up screen of the Bee Hive APP. Information entered into the APP is in clear text so that the APP user can see the information on their devices. The set up function may comprise selecting from one of several categories of information, including selecting with which third party applications to share information, selecting the encryption type, and which doctor information and user keys to use.

Once the information is entered, it is stored encrypted in the Bee Hive APP as a file that is attached to a log file. This file (encrypted) is sent via the Smartphone cell phone carrier to another Smartphone as either a SMS Text message with attachment or as an E-mail with the Bee Hive APP file as an attachment. The Smartphone will have to have the senders “public key” (or server certificate) in order to decipher the files. A “certificate” is a unique identifier similar to a “key” that may be loaded on a user's cloud server and the user's server. The recipient may send the sender their public key (or server certificate via the cloud) ahead of time and have it installed in the receiver's setup file of approved keys in their loaded Bee Hive APP).

Some embodiments of the APP are considered “open,” meaning they can operate on most of the current mobile operating systems, such as iOS®, Android®, and BlackBerry®. Such embodiments are may also be considered “open” as they do not require any other hardware to operate other than what the mobile device or smart phone device offers. An encryption key (certificate) is preferably installed in embodiments of the APP, for example during the application setup steps, so that the exchange of information may be controlled by the user and shared with their doctor and other users to ensure confidentiality and disclosure. This activity occurs when accessing cloud networks such as that provided by ORock™Cloud.

In an article published in The Washington Post on Mar. 8, 2013, entitled Army Report Details Flaws In Army's Handling Of PTSD, Other Behavioral Health Issues, a significant problem was highlighted that the US Army and society in general faces in the quick treatment of individuals to determine mental health issues. The article emphasized: “Since September 2001, the report found, 4.1 percent of all soldiers deployed wound up with a behavioral health diagnosis such as PTSD or traumatic brain injury. Many can remain on active duty.” The use of the Bee Hive App should enable the Army to immediately diagnose all US Soldiers via their smartphone apps for mental health issues in a secure and reliable fashion.

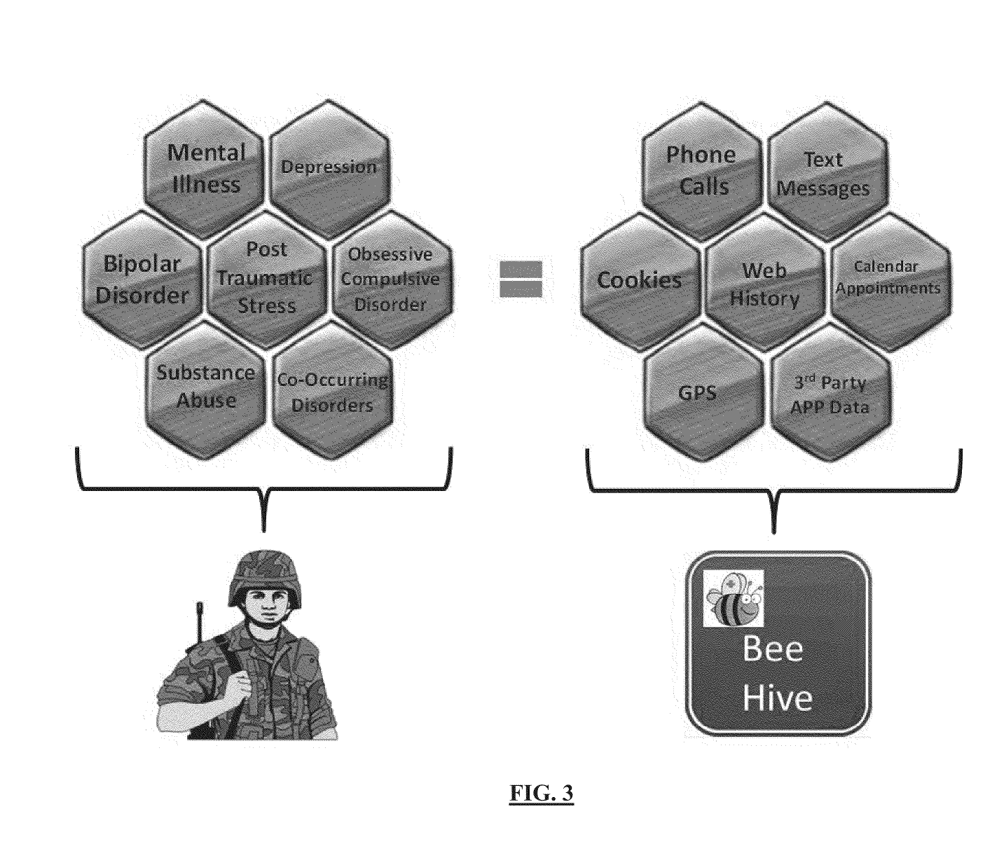

The concept behind some embodiments of the present App is to record the activity of the soldier and apply them to smart phone activity. The types of behavioral issues that the mobile device application may use in exchanging information so that members of the medical community can make a diagnosis is shown in FIG. 3.

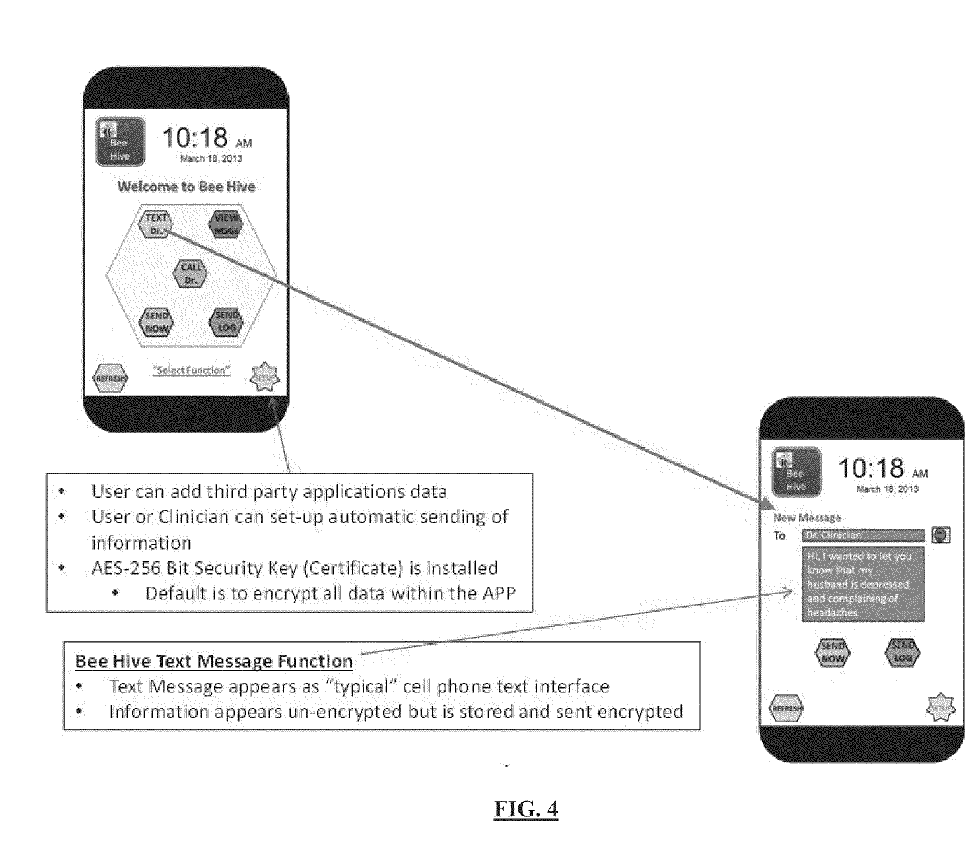

In one embodiment, an example of a text message that might be created and sent to the clinician using the application is shown in FIG. 4. An example of a “setup” icon is shown, where in some embodiments, the basis of the security of the App resides. Embodiments of the present medical application comprise preferably certain functions, including texting the doctor, viewing messages, call the doctor, sending current medical information in real time, and/or storing medical information for later transmission of some or all of such stored information.

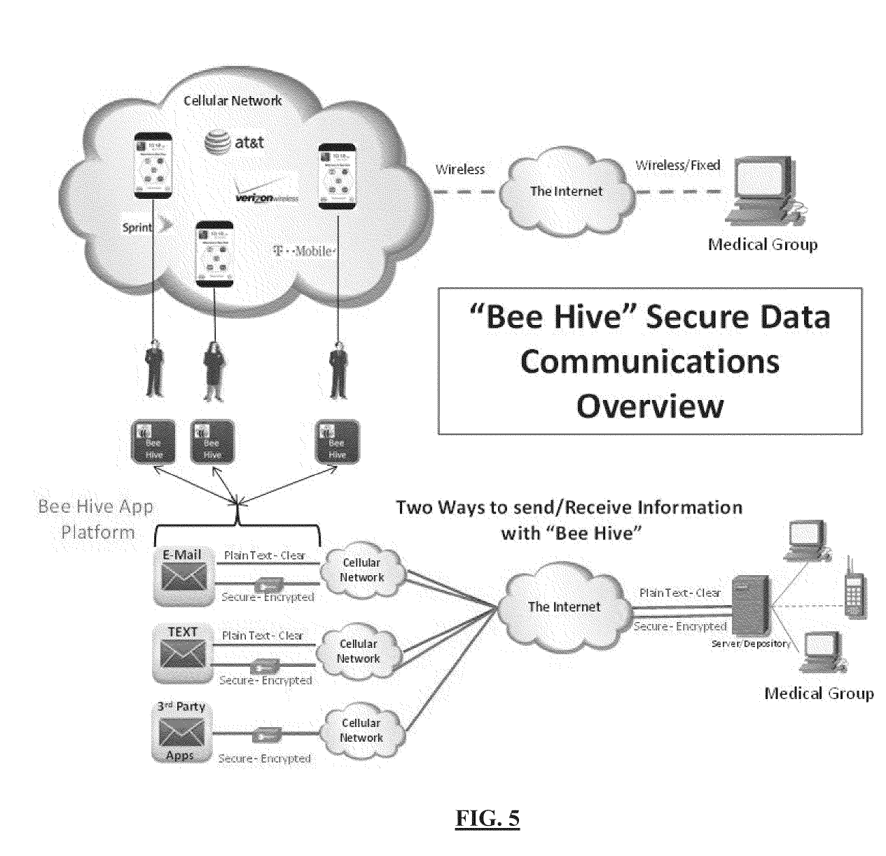

As discussed above, at least one advantage of embodiments of the present invention include the transmission of information from patient family members to clinicians providing a thorough picture of the patient's current mental health in a secure manner, supporting patient and family member's confidentiality to the doctor/clinician. One embodiment of the Bee Hive App creates a “front-end” for information used within the Bee Hive App to encrypt the information content for transmission and receipt. A high-level overview is shown in FIG. 5.

The Bee Hive App can support AES encryption (128-bit or 256-bit). The proven use of private public key is the baseline behind the use of AES encryption. The doctor/clinician can distribute to the patient and family members their public key to encrypt their smartphone data with. This supports a high degree of trust between the clinician and the patient and their family members so that they can send information “with confidence” knowing that their information and identity is protected. The goal is to have the clinician/doctor receive as much information as possible form the patient and family members. One key factor to ensure this happens is the user's confidence in using the Bee Hive App to send the information.

Some research has been conducted on current medical Apps that have similar operations that permit embodiments of the Bee Hive App to use and/or support such Apps as a third party App. Below is a list of the Apps from the research performed.

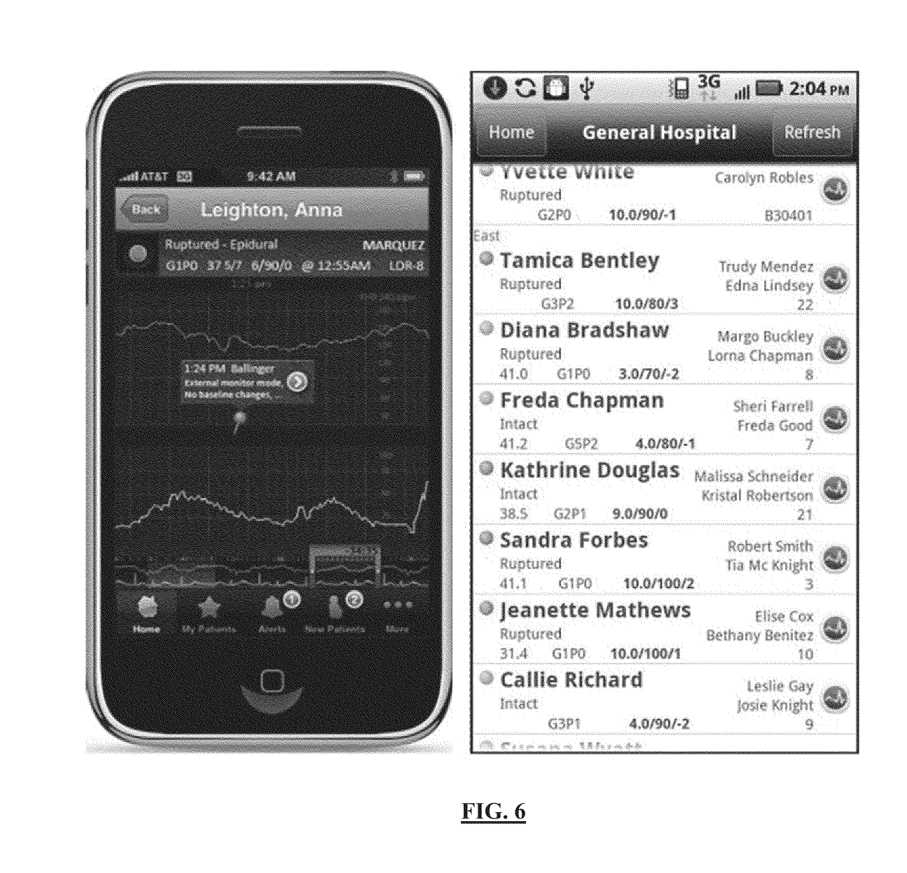

AirStripOB: This app is often referred to as the very first iPhone app to secure clearance from the Food & Drug Administration. AirStripOB is a remote monitoring application that enables physicians to monitor the vital signs of expectant mothers and the fetal heart rate of their baby. Physicians using AirStripOB can “check in” on their patients from almost anywhere (shown in FIG. 6). AirStrip recently received FDA clearance for another remote monitoring app, AirStripRPM, for critical care and cardiac patients.

The Washington Manual of Medical Therapeutics provides access to practical clinical recommendations for residents and senior medical students. Use this mobile database to quickly diagnose and treat patients with hundreds of common medical conditions.

Practical Guide to the Care of the Medical Patient is built specifically for the busy clinician or trainee who needs important diagnostic, laboratory and treatment information . . . fast. Featuring almost 400 diseases and disorders, the entries focus on need-to-know information. Extensive tables and algorithms organize complex data and combine with differential diagnosis lists for 199 symptoms to help you reach an accurate diagnosis. Clinical Pearls tap directly into Dr. Ferri's vast experience to provide useful insights into disease management.

Some third party applications include commercial fitness applications, such as may be viewed at the URL: http://blogs.wsj.com/digits/2013/03/18/not-interested-in-a-galaxy-s-4-these-gadgets-match-its-fitness-prowess/? mod=yahoo_hs). Such third party fitness Apps are interactive with mobile devices such as smart phones to gain personal information about the smart phone user. Unlike many existing medical Apps that focus on information and self-diagnosis based on search, these Apps can be tailored and its information can be shared by others. Other examples are:

Fitbit: The Fitbit tracks both your movement and your sleep patterns. It transmits that all wirelessly to apps that build detailed reports on your activity. In addition, the Fitbit data also syncs with Wi-Fi enabled weight scales.

MyFitnessPal: If you want to keep track of the amount of calories you are consuming, and how much you want to leave out in order to lose weight, MyFitnessPal has a huge database of food and activities. You can also connect with friends on MyFitnessPal and comment on their activity (or harass them if they stop using it for too long.) MyFitnessPal is free on the App Store—there are other calorie tracking apps like SparkPeople, but this is one of the best.

Lark: Like the Fitbit, the Lark will track your sleep habits, your diet and your movement. The Lark also operates as a kind of silent, vibrating alarm clock that will wake you up using your sleep patterns as a guide—getting you awake at the best moment.

Nike+ Fuel Band: This one is geared toward runners and fitness enthusiasts that like to move around. In addition to tracking your steps and calorie consumption, it also gives you a “fuel” score. You set “fuel” goals for each day depending on how much activity you want to do and how much you move around. This gadget will sync up with an app on one's iPhone®.

As alluded to above, embodiments of the invention herein are applicable to digital communication between devices and with cloud-based servers. Mobile devices (cell phones, tablets, Laptops, Notebooks, etc) use the Internet for connectivity. Cloud computing is one form of networking that uses the Internet for connectivity. Users have the ability to store and move files between their computers/mobile devices and their “cloud location.” In some embodiments of the present invention, authentication of two or more users that desire to communicate securely comprises two-way authentication, which in some embodiments may be set up prior to authenticating any users. The profile of the potential users who desire to communicate is set up with the two-way authentication provider. Information that is set up with the two-way authenticator can include (but not limited too) the users cell phone and/or email address.

Using one embodiment, User A has established their cell phone number and their personal and work email address with a two-way authentication provider (e.g., SAN Certificate), where User B has done the same. When either Users A or B log into the a cloud provider, such as ORock™Cloud, via the Internet website, their login and password is verified and authenticated with the cloud provider's active directory server.

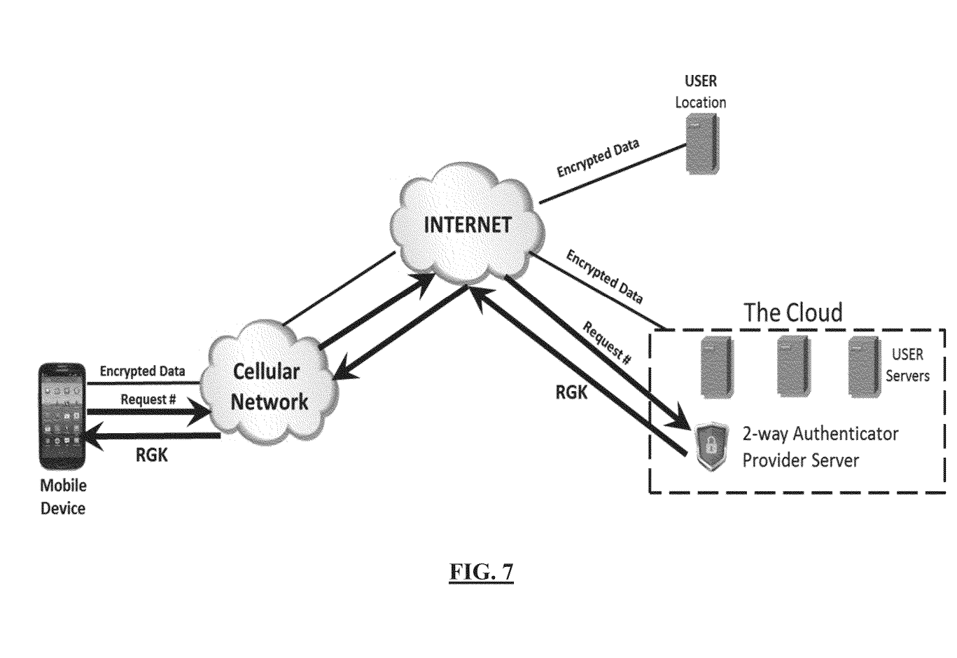

The two-way authentication provider agent operating on the website of the cloud provider may be enabled and may prompt the user with a list of options (preferably previously established). Referring to FIG. 7, a request is made requesting a random generated key (RGK) to be sent, where the RGK may comprise alphanumeric or numeric characters. To receive the RGK, the user may, for example, select “SMS Text to their cellular phone/tablet number” as an option. The RGK is sent to the user-selected location (e.g., cellular phone, tablet, computer) as shown in FIG. 7 as RGK. The user then types in the RGK into the Internet website screen. The two-way authentication provider reads the RGK and authenticates the user to the designated cloud server.

With regard to the feature of moving files from a user server to a cloud server, in one embodiment, for example, user A has a private certificate with their cloud provider. User A may have established users account(s) with the two-way authentication provider in similar manner mentioned earlier. User A may access their cloud server either via the Internet website portal or via a remote terminal connection (aka “virtual private network). In one embodiment, a server certificate (similar to public key) to establish encryption is sent upon connection. It is contemplated that in some embodiments that if the server certificate was sent previously the key need not be re-sent as it is preferably already loaded and installed in the user's computing device. All connections made with the cloud are preferably encrypted. User A can now move their files to and from their servers onto their Cloud servers in an encrypted manner. With regard to the feature of moving files from a cloud server to a user's mobile device, the user preferably is directed to follow the same process as discussed above. User A would have established their “username” and “password” in their own directory server to authenticate the user(s) to gain access to their cloud server.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A method of authenticating and encrypting data transmitted between a user and a remote cloud server, the method comprising:
providing a computer user interface for the exchange and transmission of digital information between the user and the cloud server;
permitting the user to establish a private user encryption key; and
automatically establishing a public user encryption key;
whereby the user may digitally transmit information using both the public and private keys so that the recipient of such information may only access such information if such recipient is pre-provided with both the public and private encryption keys.
